(19) United States
(12) Patent Application Publication
(10) Pub. No.: US 2018/0036661 A1
(43) Pub. Date: Feb. 8, 2018

(54) System and Method of Filtering Fibrous and Sheet Segment Materials from Waste Liquid

(71) Applicants: Patrick M. Anthony, Mt. Dora, FL (US); Richard G. Hicks, Cypress, TX (US)

(72) Inventors: Patrick M. Anthony, Mt. Dora, FL (US); Richard G. Hicks, Cypress, TX (US)

(21) Appl. No.: 15/659,954

(22) Filed: Jul. 26, 2017

Related U.S. Application Data
(60) Provisional application No. 62/371,332, filed on Aug. 5, 2016.

(51) Int. Cl. B01D 29/03; C02F 1/00; B01D 21/00

(52) U.S. Cl. CPC B01D 29/03; B01D 21/0012; C02F 1/004; B01D 2029/033

(57) ABSTRACT

A system and method of filtering fibrous and sheet segment materials from waste liquid in a dewatering process including a bar-screen filter comprising ribs and a perforated sheet, the bar-screen filter preferably partitioning a dewatering container into a collection area and a primary dewatering area.

This application relates to and claims priority to co-pending provisional application Ser. No. 62/371,332, filed Aug. 5, 2016, entitled System of Filtering Fibrous and Sheet Segment Materials from Municipal Waste Liquid, having inventors Patrick M. Anthony and Rick G. Hicks. The contents of the referenced co-pending provisional application are herein and hereby incorporated by reference in their entirety.

### FIELD OF THE INVENTION

The invention lies in the field of dewatering waste liquid and in particular in dewatering municipal waste that contains significant fibrous materials and sheet segment materials, such as “wet wipes” and the like and in the design and use of dewatering containers therefor.

### BACKGROUND OF THE INVENTION

An initial preliminary patentability search produced the following U.S. Patents. U.S. Pat. No. 4,389,314; U.S. Pat. No. 4,436,622; U.S. Pat. No. 4,543,183; U.S. Pat. No. 4,816,167; U.S. Pat. No. 5,503,753; U.S. Pat. No. 6,951,607; U.S. Pat. No. 7,037,436; U.S. Pat. No. 7,282,143; U.S. Pat. No. 9,061,623. Prior Flo Trend products, Wikipedia references and U.S. patents regarding the use of bar-screens in the “pretreatment” of waste or municipal waste flow were also consulted. None of the references solved the below identified problem that the inventors have faced and solved.

The problem the inventors address is that of particular municipal waste and septic streams which today contain daunting amounts of undissolved towels or wipes such as wet wipes or the like. Undissolved fibrous and sheet segment materials cling to, clog up and “blind” filter media, traditionally used to dewater the municipal waste.

The current state of the art may be said to be represented by the patented FloTrend Gravity Vacuum Box, U.S. Pat. No. 5,858,226. Septage and Vac-Truck liquid waste materials is a composite of grease, sand, rags and, today, more and more undissolved fibrous debris that blocks dewatering filters. The growing mass of undissolved fibrous waste does not allow a gravity vacuum system to perform well.

The standard for the industry in dewatering containers is a roll-off style dewatering filter container box with weave filter media installed over a metal mesh or perforated steel plate support on walls and floor. The weave filter media and mesh or plate support catch inorganic materials while allowing liquid to drain through, historically cost-effectively. (Models exist both with disposable filter media liner bags that are disposed each time the container is dumped, and with permanent filter media that are washed after each dump and reused.)

When waste liquid contains significant amount of undissolved medium sized and large debris, the weave filter media, both disposable and permanent, as well as the metal support structure becomes “blinded” or clogged. The debris significantly impedes the free flow of liquid through a unit. Current units are not designed to efficiently dewater both fine and large inorganic materials found in current Vac-Truck waste. Use of a tight filter weave media significantly slows down, and sometimes stops, the drainage of liquid from municipal waste material. And both municipal and industrial locations need to quickly unload a Vac-Truck and allow it to return to work. With current municipal waste large Vac-trucks are taking too long to dump and dewater through standard containers and filters. The current systems are becoming an inefficient means to dewater septic waste.

In response to this problem, the “Debris-Mate” embodiment was inventing as a roll-off container with a primary dewatering area with wall filter media that focuses on filtering and dewatering waste with small debris while including a pre-filtering means for segregating out medium and large debris. The “Debris-Mate” embodiment with a swinging gate partition/pre-filter segregates large and medium waste debris from municipal waste quickly and surprisingly completely. The “Debris-Mate” embodiment preferably gives an operator a safe way to aid and speed the dewatering of the container with the use of a rake. The “Debris-Mate” embodiment allows for a concentrated collection of large/medium waste in a load area of the container for ease of disposal. And in addition to wipes and the like the “Debris-Mate” embodiment allows for the collection of inorganic waste such as rocks, metal, wood and other items that might damage pumps and other equipment.

In various industries it has been known to place bar-screens at the entrance to structures processing fluid streams to filter out large debris. This is sometimes referred to as “pretreatment.” The instant inventors, by testing and retesting, have provided an effective bar-screen type system and method surprisingly useful and cost-effective for treating wipes and the like in municipal waste streams in dewatering containers. The invention can utilize existing systems. Although separate filter containers for large debris are known, the inventors believe that they have invented the first successful, cost-effective debris screen apparatus and method which can be deployed in existing container batch dewatering processes for municipal waste where the waste contains significant undissolved fibrous sheets and material or segments thereof. Specifically, “wipes' are the primary target.

The invention may be regarded as an in-process debris screen for dewatering containers or conduits and is particularly suited for waste stream inputs characterized by 40% to 90% liquid with grease and particulate matter and 1% to 20% significant, troublesome debris, like wipes, rags, sanitary products and with, as well, certain sludges.

Disadvantages of the instant inventive system and method are that it may take longer to load a raw waste stream into a partitioned collection area of an existing container for dewatering the waste stream than to load into the full container. Alternately a larger container could be utilized. A further disadvantage is a small extra cost for the debris screen partition and possible extra labor of raking the debris screen. Overriding advantages, however, include much faster and more complete dewatering of the waste liquid because of less fibrous sheet and mat debris clogging the dewatering filter media on the walls of the container and in providing an easier and faster cleanout of a container prior to reuse due to the fibrous sheet and mat debris largely catching on and falling to, or being raked to, the bottom of the debris screen.

In operation of a preferred embodiment it is found that a current of municipal waste or septic waste liquid flow sets up within a collection area of a dewatering container box defined by a “loading area” located aft of a bar-screen partition. In a dewatering container box of the preferred embodiment the bar-screen that partitions the container may be referred to as a “hanging gate.” The major dewatering area is located “fore” in the container, downstream of the hanging gate. Liquid flow runs through the debris bar-screen from the aft collection area to the fore dewatering area. (Aft and fore refer to the container where the fore of the container is lifted up to dump out of the aft.)

Testing shows that the current setup in the collection area tends to stir the input debris and move the debris toward the screen. And pressure from the current flow tends to hold large debris on or at the bottom of the bar-screen partition, aided by the designed slight slant of the screen, from bottom to top, the top slanted back away from the collection area. The liquid and small debris, after passing through the bar-screen into the major dewatering area, dewater faster due to the lack of the “large” fibrous mat debris that is caught by the bar-screen. This situation tends to keep the liquid level in the dewatering area lower than in the collection area and further enhances current flowing from the collection area to and through the bar-screen into the major dewatering area.

At the end of a dewatering, tests show that a significant percent of large fibrous sheet debris is at the bottom of or on the bar-screen, and is not choking the main dewatering filter media located on the container walls in the major dewatering area. This large debris can be easily pushed down and off the bar-screen manually (hence the value of a walkway above the bar-screen.) The container can be raised after dewatering for dumping debris out of the rear of the collection area end. The bar-screen is preferably hinged at the top to allow the screen to swing out and aft for the dump. Remaining sludge in both container areas, as well as the debris, slides on the floor and out the back of the container.

The invention can be installed in new or existing containers within general ranges. The optimum location of a partition in a container is likely to be somewhat dependent on the particular characteristics and composition of the waste stream and may be adjusted by trial and error. A walkway/workway across the container above the bar-screen partition provides a good location from which to push debris down and off the screen partition with a rake.

One preferred embodiment of the invention employs a container box similar to a Flo Trend existing container box but with center paneling removed to allow for a center mounted hinge gate at an approximately 22 degree angle. The gate is a cross supported bar-screen that allows flow through when the box is filling. The aft portion of the box preferably has a solid floor versus filter panels.

Influent is added from the top of the aft of the box and the bar-screen catches the large and medium debris mixed in. Depending on the origin of a septic stream, the influent can contain towels, wrappers and assorted debris which will not dissolve. Instead than blind the filters. The most common blinding debris element is “wet wipes”. This is a common problem for septic streams throughout the United States today, as “wet wipes” have become increasingly popular and do not dissolve.

In the instant invention large and medium debris is largely contained by the bar-screen in the aft portion of a filter box while the box is allowed to de-water in a normal course in the fore section but typically faster due to the pre-filtering. The bar-screen prevents blinding of the filters in the fore portion of the box by the assorted large and medium debris. The large and medium debris can be easily pulled or pushed down off of the bar-screen by rakes, preferably employed from a walkway affixed over the container. When dewatering is completed and the box is elevated to dump the debris, the hinge gate pivots up and allows the collected debris along with cake waste to slide out and be applied to land or otherwise. The end result is that the box is clean. The debris is pushed out by the cake and gravity.

The plant manager at Pasco County Florida and our representative there have not seen this design employed or being used at any other location. The invention process solves the problem of pervasive non-dissolving wet-wipes and the like in septic streams by preventing the blinding of dewatering filter media by assorted troublesome large and medium debris.

### SUMMARY OF THE INVENTION

The invention includes a system of filtering fibrous materials and sheet segment materials from liquid waste utilizing a bar-screen filter for filtering medium and large fibrous materials and sheet segment materials present in the liquid waste. The bar-screen can include a grouping of at least 4 ribs, each rib of a thickness of between 1/16^{th} of an inch and 1 inch and of a width between 2 inches and 8 inches. The grouping is preferably aligned lengthwise with a separation between ribs of between ½ inch and 8 inches. The rib thickness dimensions are preferably structured to face forward toward flow and aft toward a sheet portion, located proximate to or attached to the rib grouping. The sheet portion provides openings over at least 20% of operational flow area, the openings of a size incapable of passing a sphere of a diameter of 1 inch or greater.

The invention further includes a large and medium debris catcher system for use in dewatering container waste liquid, the system comprising a partition structured to divide a dewatering container, at between 10% and 90% of container volume, into a first collection area, which receives inflow of waste liquid to be dewatered, and a second primary dewatering area providing filter media on container walls. The filter media preferably has openings sized not to pass a sphere of ¾ inch dimeter or greater. The partition includes a bar-screen portion with spaced ribs aligned proximate to or attached to a sheet portion, the rib widths oriented predominantly orthogonal to the sheet portion. The ribs are preferably approximately ½ inch thick, 4 inches wide and spaced approximately 4 inches apart. The sheet portion provides openings over at least 20% of sheet operational flow area with the openings being of an average size as approximately the average size of the filter media utilized in the primary dewatering region on the walls.

The invention includes a bar-screen composed of a filter for substantially screening fibrous sheet and material segments from liquid waste flow including a series of ribs having a thickness of 1 inch or less and a width of between 2 inches and 8 inches. The ribs are aligned with rib widths substantially orthogonal to a proximate filter sheet, the rib widths spaced between 1 inch and 8 inches apart. The proximate filter sheet provides a plurality of openings of between 0.05 square inches and 1.5 square inches. The composite filter provides between 30% and 90% of open operational flow area for the passage liquid therethrough. The invention also includes a method of dewatering waste liquid in a container where a container provides 10 to 100 cubic yards of operational liquid level volume and has filter media on walls and has a fibrous and sheet segment materials debris catcher partitioning the container into a collection area and a major dewatering area. The collection area forms between 10% and 90% of the container volume. The method includes adding waste liquid into the collection area, passing the waste liquid through the partition from the collection area into the dewatering area, by gravity, retaining at least half of the fibrous and sheet segment materials of the waste liquid in the collection area and dewatering the passed waste liquid in the dewatering area.

### BRIEF DESCRIPTION OF THE DRAWINGS

A better understanding of the present invention can be obtained when the following detailed description of the preferred embodiments are considered in conjunction with the following drawings, in which:

FIGS. 1A, 1B and 1C illustrate views of a bar-screen assembly comprising an isometric view, a front view and a side view, respectively.

FIG. 2 illustrates a top view of a container box showing a placement of a bar-screen and walkway therein, the bar-screen partitioning the container box into a collection area and a dewatering area.

FIG. 3 provides an isometric view of a container box having a bar-screen assembly partitioning the box and illustrates filter media on side walls of the filter box.

FIGS. 4A-4G present views of or aspects of a container box having a bar-screen assembly, with FIG. 4A proving an isometric view, FIG. 4B providing a right side or aft view, FIG. 4C providing a side or front view, FIG. 4D providing a left or fore view, FIG. 4E providing a detail of the connection of the bar-screen with the container, FIG. 4F providing a side view and FIG. 4G providing a top view.

FIGS. 5A-5G provide similar views to FIGS. 4A-4G but FIGS. 5A-5G include the filter media on the side walls of the container box.

The drawings are primarily illustrative. It would be understood that structure may have been simplified and details omitted in order to convey certain aspects of the invention. Scale may be sacrificed to clarity.

### DETAILED DESCRIPTION OF PREFERRED EMBODIMENTS

The instant invention addresses the above problems by focusing on an early segregating of troublesome medium and large inorganic materials, common in municipal waste today, and thereby allowing a quicker drainage of and dewatering of liquid and the small debris from the collected waste. In chosen cases, larger openings in the metal support and filter media on the walls, and in the partition, of a dewatering container box can allow for even quicker drainage of liquid and small debris after pre-collecting selected medium and large waste material. Selection of opening size can be tailored to particular liquid waste streams

A slightly slanted and hinged bar-screen, used as a pre-screen and partition, as well as an overhead walkway, can allow operations personnel to efficiently push collected large and medium waste down away from a bar-screen with rakes, allowing more liquid to evacuate. And the design allows all debris to easily dump. Preferably an overflow window is positioned at a top center portion of a bar-screen to allow any overflow of solids and liquid loaded into a collection area to flow over the screen partition into the dewatering area, preventing spills over the container walls themselves from the collection area.

Preferably again, the bar-screen is hinged at the top to allow the whole bar-screen to swing up during unloading or dumping, thereby letting any debris trapped behind the screen to be disposed of at the same time.

The floors on preferred embodiments, especially in the collection or load area, are preferably solid metal with no filters, to prevent troublesome waste from sticking to filters there and to enhance the cleaning of the container as it is dumped.

Alternate embodiments include adding tighter support and filter media to the bottom twelve inches of the walls to allow for an additional collection of sand/grit at the same time as quickly dewatering through the remaining filters and segregating the large/medium debris. Specifically, an alternate embodiment includes replacing a 12″ strip on a lower portion of the walls with perforated steel support and tighter filter media, which would allow for the capture of fines and sand/grit while still allowing for the quick dewatering in the upper portions of the filters.

Features of the invention were developed by testing at a waste water facility. Flo Trend dewatering containers were used to dewater debris, fines and sand/grit collected by Vac-trucks from the head works of a plant. Initially units would dewater the debris but it took days to complete because of a slow drainage caused by the tight weaved filter media being clogged by the prevalent fibrous material in the municipal waste. Even though it took days to dewater this waste the Flo Trend units performed as well as other units on the market. However, Flo Trend started testing different designs, focusing on the quicker dewatering of this type of debris, including having small units on site for testing and replacing the media and media support with different open designs for allowing quicker dewatering.

Flo Trend began working with bar-screen designs to pre-capture medium/large debris. An overhead walkway was added to allow an operator to safety rake and push down large debris at the bar-screen to further release trapped liquid and further dewater the waste. With a bar-screen addition to the units Flo Trend needed to insure that the waste and liquid in front of the bar-screen would not overflow over the sides of the container causing a spill, so Flo Trend tested and designed an overflow window in the top center of the Bar-Screen, allowing solids and liquid at a certain level to flow behind the bar-screen and to continue to dewater, avoiding any spills.

To insure all waste would be dumped when the container went to the landfill, including any that may be behind the bar-screen, Flo Trend installed hinges on the bar-screen itself and slanted the bar-screen slightly in the container. The hinged slanted bar-screen would raise as the roll-off was being dumped allowing any debris behind the bar-screen to go out with the other waste.

Flo Trend designed the invention in different sizes, not only for the volume a container could hold but also to allow a Vac-truck to back up to a “Low Profile Debris-Mate” embodiment with a total height of only 38″ and dump directly into it without requiring the use of a ramp.

The resulting Flo Trend Debris Mate, forming a preferred embodiment of the instant invention, is a dewatering box designed specifically to segregate troublesome large and medium fibrous materials into a separate area to allow a more proper and rapid drainage of a box through a major dewatering area.

The Debris Mate embodiment is segmented into separate regions. An initial loading area, typically aft, may encompass up to 75% or more of the volume in the box and is divided from a primary dewatering area by a pivoting swinging bar-screen mounted substantially vertically (but at a preferred 10%-20% angle) defining the two regions. This bar-screen preferably includes ribs preferably welded to a perforated (typically ¼″-¾″) drilled hole ⅜″ thick aluminum plate. The ribs are preferably aligned with their thickness dimension facing flow and providing 1 to 8 inches of width, with 4 inches working well. Such design has been shown to allow large and medium debris from municipal waste to be screened out in a loading area while allowing water and smaller material to flow through to the back of the box, typically the fore section, which functions as the primary dewatering area, with the large and medium debris being largely collected on or at the bar-screen.

Illustrative drawings of the Debris Mate show one preferred embodiment of the invention. Alternative embodiment include using interchangeable perforated plates, with different size orifice holes, for operational flexibility. Automatic bar-screen raking apparatus could also prove to be beneficial.

Testing indicated that simply removing the standard dewatering filter media material and using instead the ⅜″ hole plate support did not perform as effectively as the instant invention. It was noted with a test unit that simply using horizontal, higher diameter filter media material backed by expanded metal on the floor was not as effective as the instant invention. Embodiments utilizing a substantially vertical bar-screen, a perforated back plate, and higher diameter filter media material and expanded metal on the walls, in conjunction with a solid floor aft, proved commercially successful.

Debris-Mate Dewatering Container Testing Notes—Pasco County (September 2014 to April 2015 Estimated)

Pasco County WWTP has 7 Units/RB-40-O-G/V′s it was currently using to dewater the Vac-Truck waste from the head works of the main wastewater plant.

Most of the debris was mainly wipes and adult pads, plus other large debris.

These existing units are not dewatering the debris completely or quickly enough.

Made several trips to location to try to resolve dewatering problem for customer. Each time Flo Trend tried disposable liners with Poly 2004 filter media, Poly 2004 media alone and disposable liners only. Did not find a correct combination that would both catch all the large debris and dewater quickly.

Finally meet with operator to go over needs for dewatering this debris. The head operator has made a make-shift confinement using concrete barriers to hold the Vac-Waste in this area and allow the liquid to drain out between barriers to area drains going back to Wet Well at the Head works of the plant. Operator stated he only wanted to catch the large/medium debris and wipes. The fines were not a priority for this application. The unit can be very open for this use as long as it dewaters quickly and captures the large/medium debris and wipes.

Flo Trend went over the details and decided to run a pilot test using a smaller container with very open filters, to start trails and work from there.

Sit up a 5 cubic yard Self Dumping Hopper with filter on back, sides and floor for a pilot. Replaced all perforated steel plate with expanded metal to allow faster dewatering of debris.

Worked with Pasco County to set up date to start pilot and started with first Vac-Truck dumping in container. The unit plugged before ⅓ load was dumped. Once we dumped the unit a lot of the large debris stuck to all the expanded metal filters. The expanded metal would dewater to a point and then the screens would plug. With no way to clean filters during the Vac-Truck dumping, we could not completely empty the trucks. Plus you still had to use high pressure sprayers to clean the screens.

That evening it was discussed that waste haulers used a sheet of perforated steel to dewater Port a Potty and Septic waste, and used a squeegee on a handle to push down built-up debris on the wall, releasing trapped water from the body of the mass. It worked well enough but the hauler had problems dumping and getting the waste from behind the wall.

Flo Trend decided that to create and hinge an internal screening wall, the hinge to allow the debris behind out the screen during dumping and which would help push the bulk of the debris out towards the back end of the unit when it's dumped.

Flo Trend designed vertical ribs to catch and deflect the wipes and pads just prior to the perforated sheet and to add needed support and strength to the perforated sheet, and to be used as guides for the rake to clear debris.

Flo Trend designed a walkway/work area to be mounted with hand rails above the segregating gate wall so that an operator could stand on it to use a rake to clear the wall. The walkway/work area is mounted to the container so it will not interfere with dumping the container. Walkway hand rails will be removable or will lay down and be locked in place so not to interfere.

Flo Trend worked with draftsmen at Flo Trend to design the container, using Flo Trend containers hulls for the Debris Mate base.

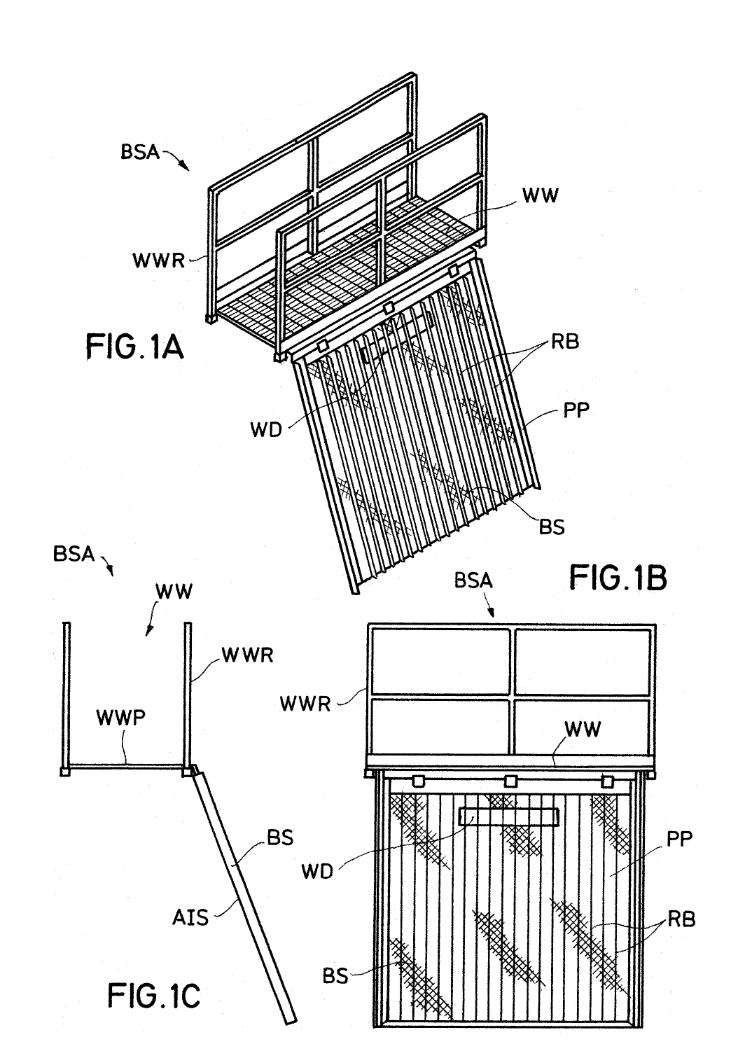

FIGS. 1A, 1B and 1C illustrate one embodiment of a bar-screen assembly BSA. FIG. 1A offers an isometric view of the bar-screen assembly comprising a bar-screen BS and a walkway WW. Bar-screen BS is shown with ribs RB and perforated plate PP. In the embodiment of FIGS. 1A, 1B and 1C ribs RB are attached to perforated plate PP. Preferably the ribs have a thickness of between 1/16^{th} to 1 inch and the width of between of 2 inches and 8 inches. The thickness side of the ribs is faced toward the direction of flow. That places the width dimension of the ribs orthogonal to the perforated plate. In one preferred embodiment the ribs are approximately ½ inch thick and 4 inches wide and spaced approximately 4 inches apart over the perforated plate. Walkway WW preferably contains removable rails WWR on both sides of a platform WWP to provide safety for operators working over the bar-screen. FIG. 1B illustrates a front view of a bar-screen assembly. The perforated plate PP is indicated as having ½ inch holes. The dimensions of the perforated plate and ribs indicate the operational flow area of the bar-screen in for the particular container box and waste stream for which it is designed. Window WD at the top of the perforated plate provides a safety overflow area for the front load region or collection area of the container box. Bar-screen angle and supports AIS help support the bar-screen against the force of the collected debris within a collection box. FIG. 1C provides a side view of the bar-screen assembly BSA.

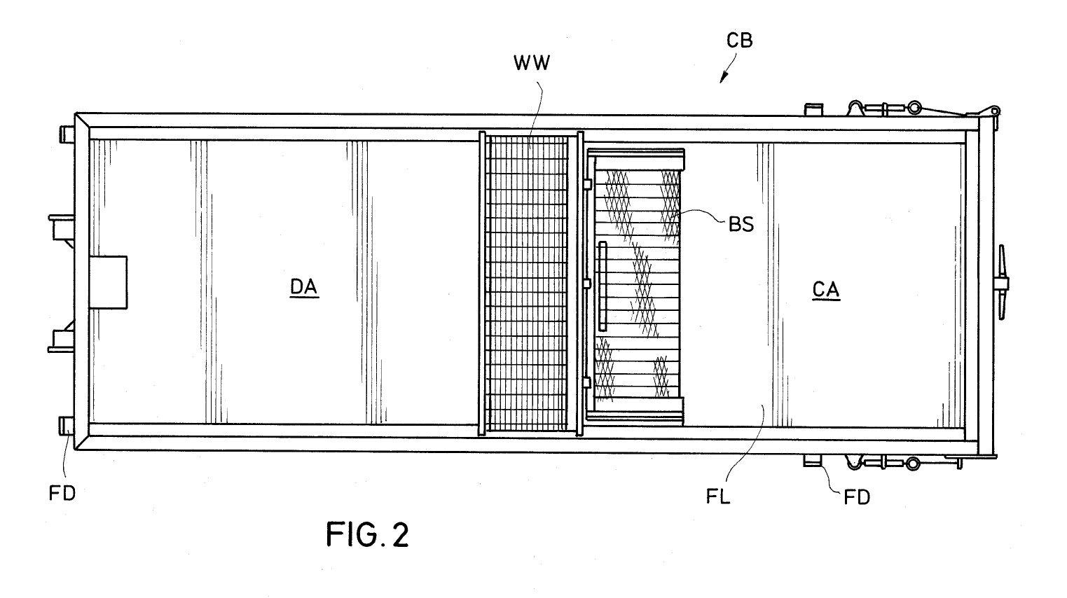

FIG. 2 provides a top view of a bar-screen assembly situated within a container box CB. It can be seen that the bar-screen BS partitions the container box CB into an aft collection area CA and a dewatering area DA. A floor area of the collection area FL is preferably coated with black mastic. Filter drains FD for the container box are illustrated. It is indicated that the collection area forms the aft area of the container whereas the dewatering area forms the fore area. It can be seen that the walkway WW can be affixed atop a container box.

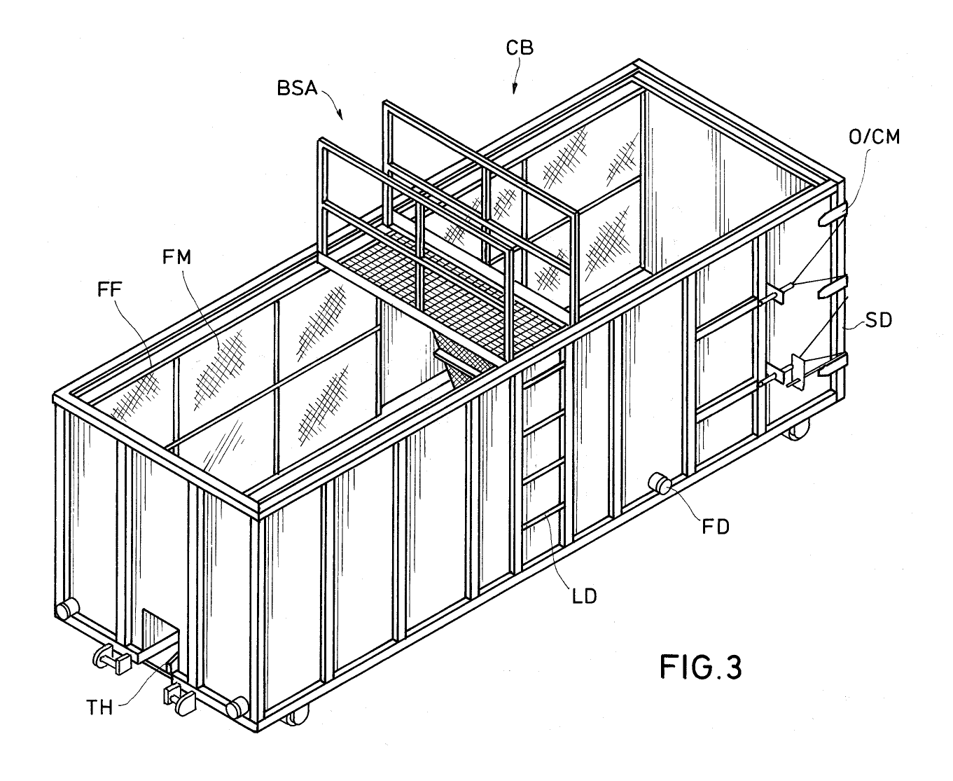

FIG. 3 provides an isometric view of a container box CB showing a bar-screen assembly BSA installed within the box. FIG. 3 indicates the filter material or media FM installed on the walls of the container box within a filter frame FF. FIG. 3 also indicates the tow mechanism on a typical fore section of a container box as well as a swing door SD on the aft section of a container box with opening/close mechanism O/CM. A typical ladder LD is illustrated on a side of the box, as well as again a filter drain FD.

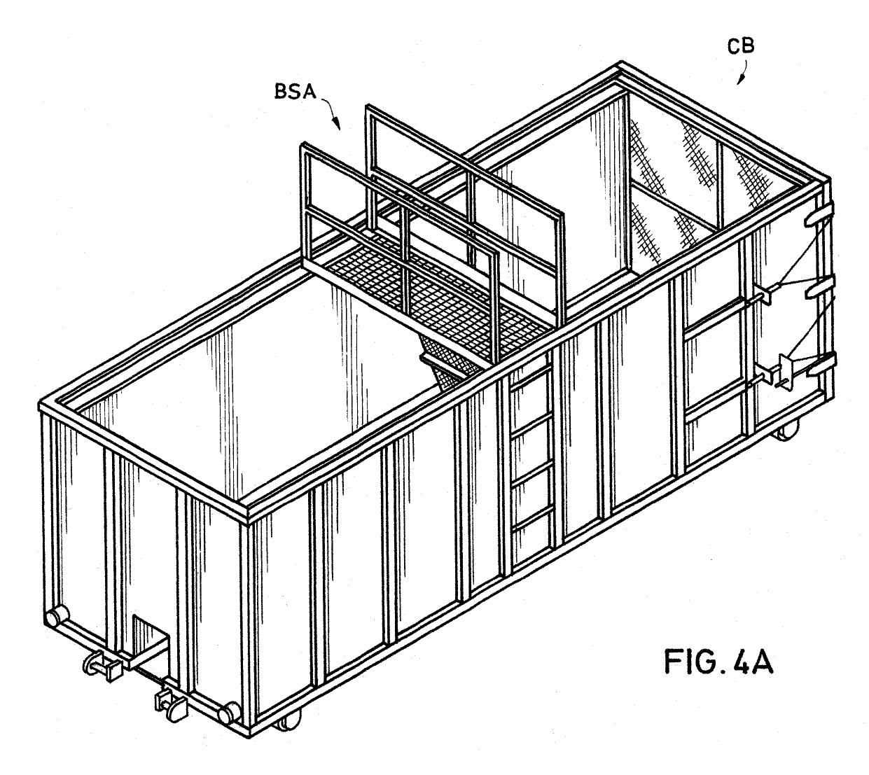

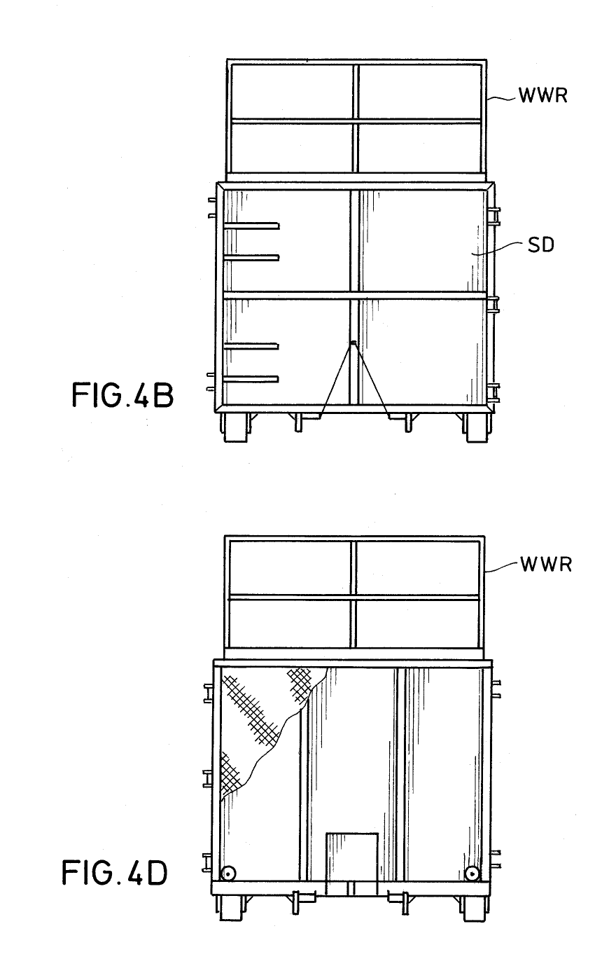

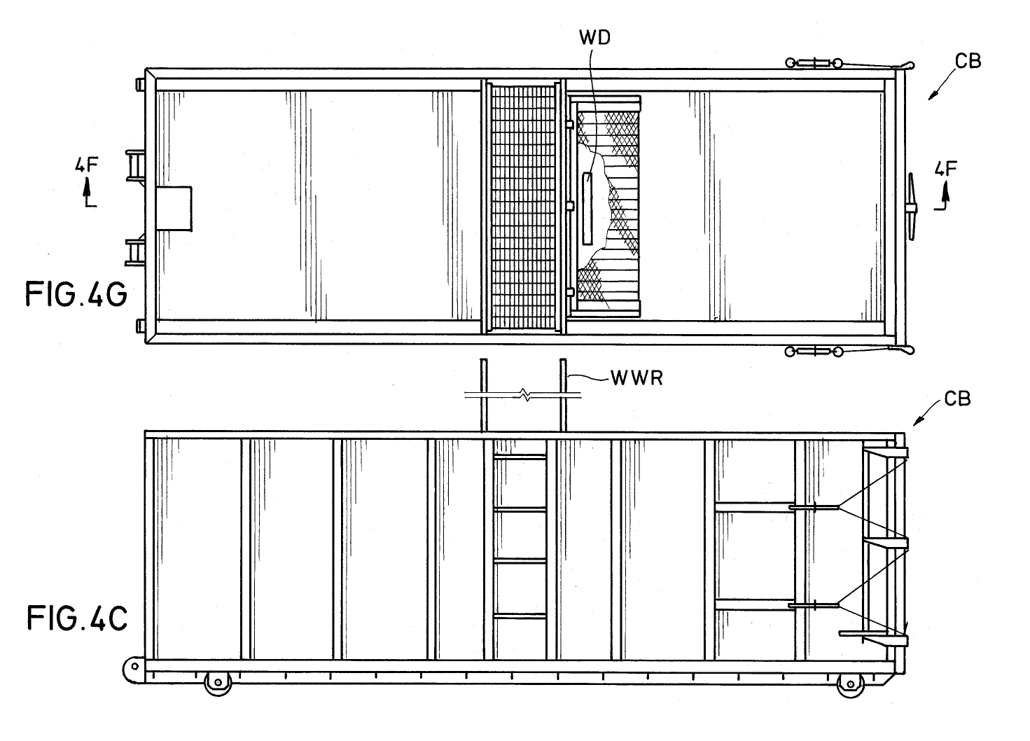

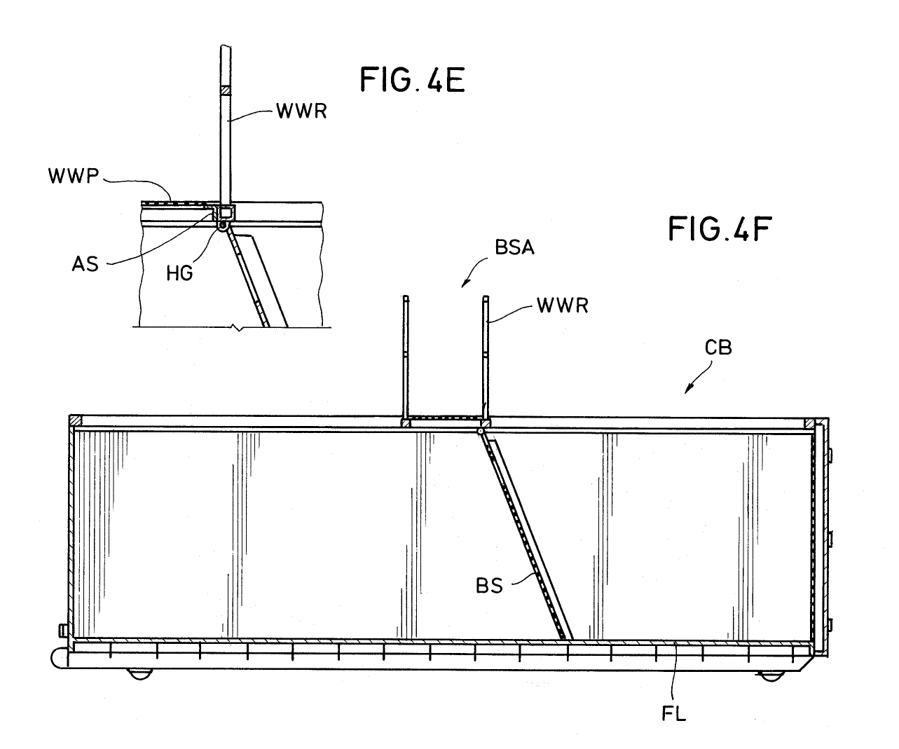

FIGS. 4A-4G illustrate various views of a preferred embodiment of the invention installed within a container box. FIG. 4A provides an isometric view of the container box CB with a bar-screen assembly BSA installed therein. FIG. 4B offers a right side or aft end view of the container box showing the swinging door SD and indicating the walkway rails WWR visible on top of the box. FIG. 4C illustrates a side or front view of the container box indicating again the walkway rails. FIG. 4D offers a fore or left side view of the container box indicating again the walkway rails on top of the box. FIG. 4E is a detail indicating the platform of the walkway WWP, the walkway rails WWR, a hinge HG for the bar-screen BS as well as the angle support AS for the bar-screen. FIG. 4F illustrates a side cutaway view of the container box showing the installation of the bar-screen assembly within the container box. FIG. 4G illustrates a top view of the container box showing the bar-screen installed therein and in particular window WD.

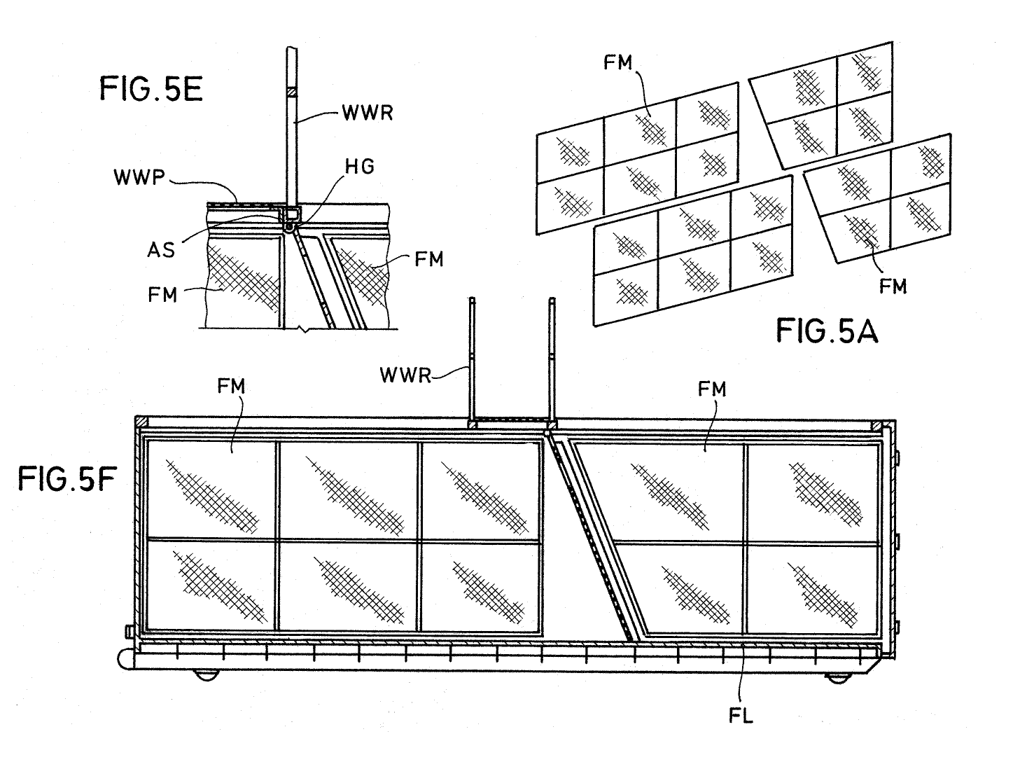

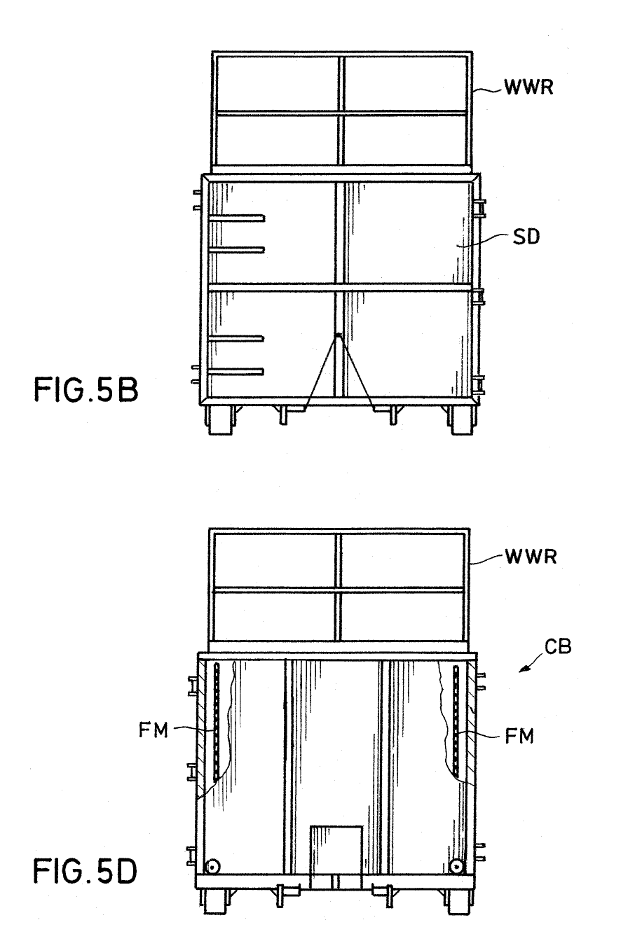

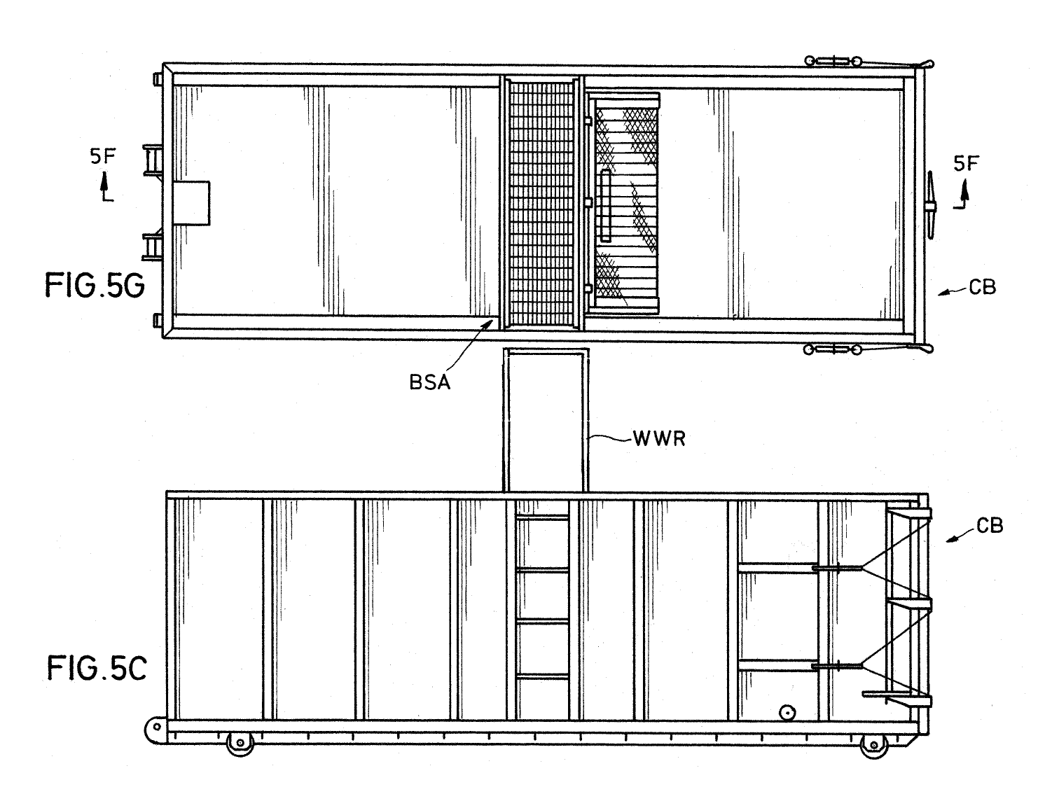

FIGS. 5A-5G illustrate a container box and in particular illustrate preferred locations of filter media FM within a container box of the instant invention. FIG. 5A offers an isometric view of the container box with the filter media FM. FIG. 5B illustrates a right side or aft view of the container box. FIG. 5C illustrated a side or front view of the container box. FIG. 5D illustrates a front or left side view of the container box. FIG. 5E illustrates a detail of the container box illustrating filter media on the walls of the container box. FIG. 5F illustrates a cutaway side view of the container box illustrating filter media on the wall of the container box. FIG. 5G illustrates a top view of the container box.

The foregoing description of preferred embodiments of the invention is presented for purposes of illustration and description, and is not intended to be exhaustive or to limit the invention to the precise form or embodiment disclosed. The description was selected to best explain the principles of the invention and their practical application to enable others skilled in the art to best utilize the invention in various embodiments. Various modifications as are best suited to the particular use are contemplated. It is intended that the scope of the invention is not to be limited by the specification, but to be defined by the claims set forth below. Since the foregoing disclosure and description of the invention are illustrative and explanatory thereof, various changes in the size, shape, and materials, as well as in the details of the illustrated device may be made without departing from the spirit of the invention. The invention is claimed using terminology that depends upon a historic presumption that recitation of a single element covers one or more, and recitation of two elements covers two or more, and the like. Also, the drawings and illustration herein have not necessarily been produced to scale.

What is claimed:

1. A system of filtering fibrous materials and sheet segment materials from liquid waste, comprising:
a bar-screen filter for fibrous material and sheet segment material present in liquid waste including
a grouping of at least 4 ribs, each rib of a thickness of between 1/16 inch and 1 inch, and of a width between 2 inches and 8 inches;
the grouping aligned lengthwise with a separation between the rib widths of between ½ inch and 8 inches such that rib thickness dimensions face forward, toward flow, and aft toward a sheet portion located proximate to or attached to the rib grouping;
the sheet portion providing openings over at least 20% of operational flow area, the openings of a size incapable of passing a sphere of a diameter of 1 inch or greater.

2. The system of claim 1 with the openings of the sheet portion incapable of passing a sphere of a diameter of ¾ths of an inch or greater and wherein the sheet portion provides openings over at least 50% of operational flow area.

3. The system of claim 1 including the filter affixed within a dewatering container for municipal waste liquid and with the grouping of ribs attached, directly or indirectly, to the sheet portion and with the bar-screen filter structured in combination with the container to partition the container into an aft end and a fore end.

4. The system of claim 3 wherein the container includes a fore end that raises to dump debris out of an aft end and with the partitioning filter hingedly connected to the container and structured to rest at an angle of 20°+/−10° to a container floor.

5. The system of claim 3 wherein container walls contain filter media structured to be incapable of passing a sphere with diameter of ¾ inch or greater.

6. The system of claim 3 with the filter partition dividing the container between 30% to 70% into a first liquid collection area aft and a second main liquid outflow area fore, the liquid collection area having at least a predominantly solid floor.

7. The system of claim 3 including the filter partition hingedly connected to a walkway/workway structured for traversing a top portion of the container.

8. A large and medium debris catcher system for use in dewatering container waste liquid, the system comprising:
a partition structured to divide a dewatering container at between 10% and 90% of container volume into a first collection area which receives inflow of waste liquid to be dewatered and a second dewatering area providing filter media on container walls, the filter media having openings sized to not pass a sphere of ¾th inches diameter or greater;
the partition including a bar-screen portion including spaced ribs attached proximate to a sheet portion with rib widths oriented predominantly orthogonal to the sheet portion, the ribs being approximately ½ inch thick, 4 inches wide and spaced approximately 4 inches apart, the sheet portion providing openings over at least 20% of sheet operational flow area, said openings being of an average size approximately the same as the average filter media size of opening.

9. The system of claim 8 including the partition structured and located with respect to the dewatering container such that a top of the partition slants away from the collection area and at least a portion of a floor of the collection area includes a solid bottom section.

10. The system of claim 8 including the sheet portion providing openings over at least 40% of sheet operational flow area, and including a solid bottom section comprised of steel and including the partition structured to divide the container to provide a collection area of between 30% and 70% of the container volume.

11. A bar-screen composite filter for substantially screening fibrous sheet and material fragments from liquid waste flow, comprising:
a series of ribs having an edge thickness of 1 inch or less and a width of between 2 inches and 8 inches;
the ribs aligned with rib widths substantially orthogonal to a proximate filter sheet, the rib widths spaced between 1 inch and 8 inches apart;
the proximate filter sheet providing a plurality of openings of between 0.05 square inches and 1.0 square inches each;
the composite filter providing between 30% and 90% of open operational flow area for the passage of liquid therethrough.

12. The composite filter of claim 11 with the ribs having a width of approximately 4 inches and with a spacing between the ribs aligned proximate the filter sheet of approximately 4 inches.

13. The composite filter of claim 11 wherein the filter sheet provides approximately circular openings of approximately ⅜ inch diameter at approximately ½ inch centers and the composite filter provides approximately 60% to 80% of open operational flow area.

14. The composite filter of claim 11 structured to partition a container for dewatering municipal waste into a primary collection area and a primary dewatering area so as to substantially screen large and medium fibrous sheet fragments from passing through the collection area into the dewatering area while permitting associated liquid and small debris to flow through and including the bar-screen composite filter structured for location in a mid-region of the container dividing the collection area and the dewatering area into somewhere between 30% and 20% of volume.

15. The composite filter of claim 14 including the bar-screen composite filter hinged such that a lower portion of the bar-screen tends to rotate toward the collection area by gravity upon raising the dewatering area.

16. The composite filter of claim 14 including the bar-screen composite filter sized to rest at an angle with respect to a container bottom portion, the angle oblique with respect to the bottom portion as measured from the collection area to the partition when the container is level.

17. A method of dewatering waste liquid in a container, the container providing 10 to 100 cubic yards of operational liquid level volume and having filter media on walls and having a fibrous and sheet segment materials debris catcher partitioning the container into a collection area and a major dewatering area, the collection area forming between 10% to 90% of the container volume, the method comprising:
adding waste liquid into the collection area;
passing the waste liquid through the partition from the collection area into the dewatering area by gravity;
retaining at least half of the fibrous and sheet segment materials of the waste liquid in the collection area; and
dewatering the passed waste liquid in the dewatering area.

18. The method of claim 17 wherein the fibrous and sheet segment materials debris collector provides aligned ribs proximate a filter sheet with openings over at least 20% of an operational flow over area with the openings of a size at least the same as the average size of the openings of wall filter media.

19. The method of claim 17 including a solid bottom portion in a collection area floor.

20. The dewatering container of claim 17 including pushing fibrous and sheet segment materials off of the debris collector from an upper walkway/workway structured for connection across the top of the container.
